(19) United States
(12) Patent Application Publication
(10) Pub. No.: US 2015/0017835 A1
(43) Pub. Date: Jan. 15, 2015

(54) UNIVERSAL SERIAL BUS APPARATUS AND ELECTRONIC DEVICE INCLUDING UNIVERSAL SERIAL BUS APPARATUS

(71) Applicant: Samsung Electronics Co., Ltd., Gyeonggi-do (KR)

(72) Inventors: Young-Bae Sim, Gyeongsang buk-do (KR); Kang-II Kim, Gyeongsang buk-do (KR); Min-Soo Kim, Gyeongsang buk-do (KR)

(73) Assignee: Samsung Electronics Co., Ltd.

(21) Appl. No.: 14/309,313

(22) Filed: Jun. 19, 2014

(30) Foreign Application Priority Data
Jul. 9, 2013 (KR) 10-2013-0080064

(51) Int. Cl. H01R 13/66

(52) U.S. Cl. CPC H01R 13/6691
USPC 439/620.01

(57) ABSTRACT

An electronic device includes a power receiver that manages power transmitted from an outside; and a receptacle including a plurality of first basic connection terminals based on a first Universal Serial Bus (USB) interface and a plurality of first expansion connection terminals based on a second USB interface, wherein the first expansion connection terminals includes one or more first power supply terminals that transmit power received through a cable device connected with the receptacle to the power receiver.

### PRIORITY

This application claims priority under 35 U.S.C. §119(a) to Korean Application Serial No. 10-2013-0080064, which was filed in the Korean Intellectual Property Office on Jul. 9, 2013 the entire content of which is incorporated herein by reference.

### BACKGROUND OF THE INVENTION

1. Field of the Invention

The present invention generally relates to a Universal Serial Bus (USB) apparatus, a receptacle apparatus, and a plug apparatus connected to the receptacle apparatus.

2. Description of the Related Art

A Universal Serial Bus (USB) which is widely used as a computer peripheral device interface can perform Plug and Play (PnP), automatic ID allocation, and a hot plug function, unlike conventional parallel buses. Particularly, a USB cable device has only four lines, that is, two signal lines, a power line, and a ground line. Accordingly, making a fine cable device and a small receptacle is feasible and thus production costs may be reduced. Further, the development of cheap peripheral devices becomes possible. As a result, a USB technology has become an industrial standard for connecting peripheral devices to a personal computer or a laptop computer, and is widely applied to portable terminal apparatuses as well.

The USB device may include a USB receptacle and a USB plug connected to the receptacle. In general, the USB receptacle is provided to a power supply adaptor, a personal computer, or a laptop computer, and the USB plug is provided to one end (or both ends) of a cable. Further, one end of the cable is connected to the USB receptacle provided to the power supply adaptor, the personal computer, or the laptop computer through the USB plug, and the other end of the cable is connected to a portable terminal apparatus.

### SUMMARY OF THE INVENTION

While power provided from a device (for, example, a laptop computer) including a USB receptacle can be supplied to a portable terminal apparatus through a USB plug connected with a cable, power provided from the outside cannot be supplied to the device (for example, the laptop computer) including the USB receptacle, through the receptacle. The present invention has been made to solve the above problems and disadvantages, and to provide at least the advantages described below. Accordingly, an aspect of the present invention provides a Universal Serial Bus (USB) device capable of bidirectional power transmission while using the currently widely used USB.

In accordance with an aspect of the present invention, an electronic device is provided. The electronic device may include a power receiver that manages power transmitted from an outside; and a receptacle including a plurality of first basic connection terminals based on a first Universal Serial Bus (USB) interface and a plurality of first expansion connection terminals based on a second USB interface, wherein the first expansion connection terminals may include one or more first power supply terminals that transmit power received through a cable device connected with the receptacle to the power receiver.

In accordance with another aspect of the present invention, a cable device is provided. The cable device may include a first plug including a plurality of first basic connection terminals based on a first USB interface and a plurality of first expansion connection terminals based on a second USB interface; and a second plug including a plurality of connection terminals based on the second USB interface, wherein the first expansion connection terminals may include one or more power supply terminals connected with a receptacle included in an electronic device that receives power to transmit power supplied through the second plug to the receptacle.

In accordance with another aspect of the present invention, a receptacle device is provided. The receptacle device may include a plurality of first basic connection terminals based on a first USB interface; and a plurality of first expansion connection terminals based on a second USB interface, wherein the first expansion connection terminals may include one or more first power supply terminals that transmit power received through a cable device connected with a receptacle to a power receiver included in an electronic device.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a configuration of a USB connection system according to an embodiment of the present invention;

FIG. 2 illustrates a detailed configuration of a receptacle device according to an embodiment of the present invention;

FIG. 3A illustrates an embodiment of a detailed configuration of a cable device according to an embodiment of the present invention;

FIG. 3B illustrates another embodiment of the detailed configuration of the cable device according to an embodiment of the present invention;

FIG. 4A is a perspective view illustrating a structure of a receptacle device according to an embodiment of the present invention;

FIG. 4B is a perspective view illustrating a structure of a plug included in a cable device according to an embodiment of the present invention; and

FIG. 5 is a block diagram illustrating a configuration of a USB connection system according to another embodiment of the present invention.

### DETAILED DESCRIPTION OF EMBODIMENTS OF THE PRESENT INVENTION

Hereinafter, embodiments of the present invention will be described with reference to the accompanying drawings. However, the present invention is not restricted or limited by the embodiments. The same reference numerals represented in each of the drawings indicate elements that perform substantially the same functions.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. The terms used in this application are for the purpose of describing particular embodiments only and are not intended to be limiting of the present invention. As used herein, the singular forms are intended to include the plural forms as well, unless the context clearly indicates otherwise.

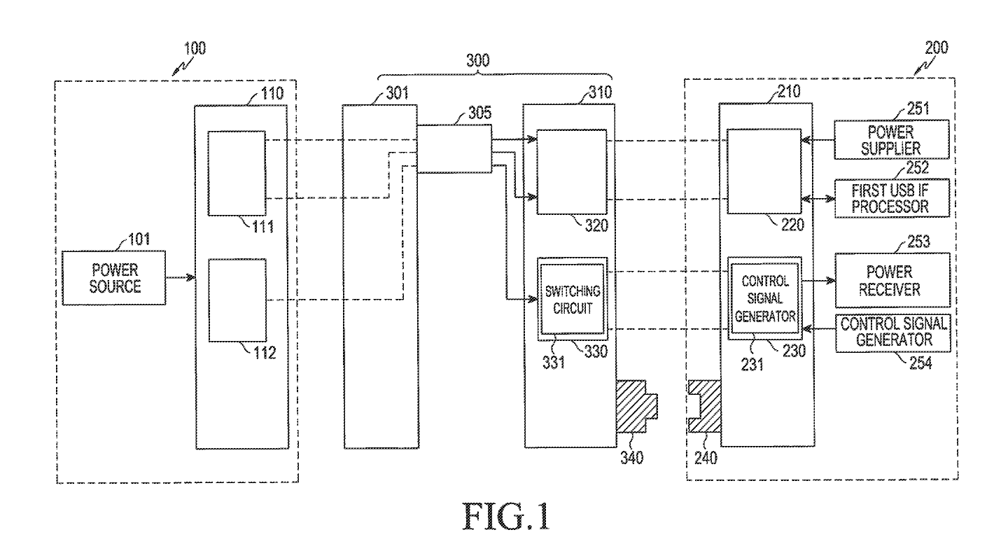

FIG. 1 is a block diagram illustrating a configuration of a USB connection system according to an embodiment of the present invention.

According to the USB connection system illustrated in FIG. 1, a first electronic device 100 and a second electronic device 200 include receptacles (a first receptacle 110 and a second receptacle 210, respectively), and are connected to each other through a cable device 300.

The cable device 300 may include a first plug 301 and a second plug 310 arranged at both ends of a cable 305. The first plug 301 may be coupled and connected with the first receptacle 110, and the second plug 310 may be coupled and connected with the second receptacle 210.

The first electronic device 100 may include the first receptacle 110 which can accommodate the first plug 301 for connection with the first plug 301. The first receptacle 110 includes a first connector 111 including one or more connection terminals to perform data communication through a first USB interface scheme. For example, the first USB interface may be an interface satisfying the USB 2.0 standard. Further, the first receptacle 110 further include a second connector 112 including a plurality of connection terminals defined by a second USB interface in addition to the first connector 111 defined in the first USB interface. For example, the second USB interface may be an interface defined by the USB 3.0 standard, and the second connector 112 may include a plurality of expansion terminals defined by the USB 3.0 standard.

The first electronic device 100 is a device for supplying power received from the outside to an electronic device, and may be, for example, a power supply adaptor. Accordingly, the first electronic device 100 may include a power source 101 that converts power input from the outside (or power stored in the inside) to power which can be supplied to the electronic device and provides the converted power. The power source 101 is connected with the second connector 112 of the first receptacle 110 and provides output power to another electronic device through the second connector 112 of the first receptacle 110.

Further, the power source 101 may be one or more batteries (not shown) arranged at a housing of the first electronic device 100 or include a power circuit that supplies power to the battery. The power source 101 may supply power input from an external power source (not shown) through a wired cable connected to a connector included in the first electronic device 100 to components (or another external electronic device) included in the first electronic device 100. Also, the power source 101 may supply power wirelessly input from an external power source through a wireless charging technology to components (or another external electronic device) included in the first electronic device 100.

Meanwhile, the second electronic device 200 may include the second receptacle 210 which can accommodate the second plug 310 for connection with the second plug 310. The second receptacle 210 may include a plurality of connection terminals corresponding to the second plug 310. That is, the second receptacle 210 may include the first connector 220 including a plurality of connection terminals supporting the first USB interface. The first connector 220 may include one or more connection terminals to supply power to the second plug 310 based on the first USB interface and one or more connection terminals to perform data communication with the second plug 310 through the first USB interface scheme. For example, the first USB interface may be an interface satisfying the USB 2.0 standard. Accordingly, the first connector 220 may include one connection terminal used to supply power to the second plug 310, and the one connection terminal connected with a power supplier 251 of the second electronic device 200. The first connector 220 may include two connection terminals performing data communication according to the USB 2.0 standard, and the two connection terminals connected with a first USB interface processor 252 to transmit a data signal provided from the second plug 310 connected to the first electronic device 100 to the first USB interface processor 252 or to provide a communication path through which a data signal provided from the first USB interface processor 252 is transmitted to the first electronic device 100. Further, the first connector 220 may include a ground terminal which can be connected to a ground end included in the second receptacle 210.

Particularly, the second receptacle 210 according to the present invention further may include a second connector 230 including a plurality of connection terminals defined by the second USB interface in addition to a plurality of connection terminals defined by the first USB interface. For example, the second USB interface may be an interface defined by the USB 3.0 standard, and the second connector 230 may include a plurality of expansion terminals defined by the USB 3.0 standard.

The second connector 230 may be connected to the second plug 310 to perform a function defined by the second USB interface. In addition, when the second connector 230 is connected with the second plug 310, the second connector 230 may transmit power provided from a device (for example, first electronic device 100) connected to the second plug 310 to a power receiver 253 of the second electronic device 200.

However, as described above, the second plug 310 selectively provides power to the second receptacle only which can accept power provided from the outside. Accordingly, the second receptacle 210 may provide a control signal to the second plug 310 when being connected with the second plug 310.

The control signal is a signal provided by a component (for example, a control signal generator 254) included within the second electronic device 200 or a signal generated by the second receptacle 210 itself. Preferably, the control signal is a low signal (“0”). Accordingly, when the control signal is provided by a component such as the control signal generator 254 included within the second electronic device 200, the second receptacle 210 transmits the control signal simply to the second plug 310, and may be connected with, for example, a connection terminal included within the second electronic device 200. In contrast, when the control signal is generated by the second receptacle 210, the second receptacle 210 may further include the control signal generator 231 for generating the control signal. Further, the control signal generator 231 may be a connection terminal or include a terminal connected to the connection terminal, and may generate a control signal corresponding to a low signal (“0”) through such a configuration. As shown, the control signal generator 231 is included in the second connector 230.

The power supplier 251 may be one or more batteries (not shown) arranged at a housing of the second electronic device 200 or include a power circuit that supplies power to the battery. The power receiver 253 may include a circuit that provides charging power to the one or more batteries included in the second electronic device 200 or a circuit that supplies power to components included within the second electronic device 200. Accordingly, the power receiver 253 may provide power provided from a device (for example, first electronic device 100) connected through a cable device 300 to the one or more batteries as the charging power or provides power to the components included within the second electronic device 200 to power the operations of the components.

Meanwhile, since the first plug 301 included in the cable device 300 may be coupled and connected with the first receptacle 110, the first plug 301 may include a plurality of connection terminals corresponding to the connection terminals of the first receptacle 110. Specifically, the first plug 301 is for data communication based on the first USB interface scheme and may include one or more connection terminals connected with the first connector 111 of the first receptacle 110 and a plurality of connection terminals connected with the second connector 112 including a plurality of expansion terminals defined by the second USB interface.

Further, the second plug 310 may include a first connector 320 including a plurality of connection terminals supporting the first USB interface. The first connector 320 may include one or more connection terminals to receive power from the second receptacle 210 based on the first USB interface and one or more connection terminals to perform data communication with the second receptacle 210 through the first USB interface scheme. For example, the first USB interface may be an interface satisfying the USB 2.0 standard. Accordingly, the first connector 320 may include one connection terminal used to transmit power supplied from the power supplier 251, and the connection terminal may be connected to the connection terminal of the first plug 301 for power transmission. The first connector 320 may include two connection terminals performing data communication according to the USB 2.0 standard, and the two connection terminals are connected with the connection terminal of the first plug 301 for the data communication based on the first USB interface scheme. Further, the first connector 320 further may include one ground terminal which can be connected to a ground end of a USB connector device 110.

Particularly, the second plug 310 further may include a second connector 330 including a plurality of connection terminals defined by the second USB interface in addition to a plurality of connection terminals defined by the first USB interface. For example, the second USB interface may be an interface defined by the USB 3.0 standard, and the second connector 330 may include a plurality of expansion terminals defined by the USB 3.0 standard.

The second connector 330 may be connected with the second receptacle 210 to perform a function defined by the second USB interface. In addition, the second connector 330 may be connected with the power source 101 included in the first electronic device 100 to transmit power provided from the power source 101 to the power receiver 253 through the second receptacle 210. However, if power provided from the power source 101 is transmitted to the second electronic device 200, when the second electronic device 200 including the second receptacle 210 is not configured to accept power provided from the power source 101, the second electronic device 200 may be damaged. Accordingly, it is necessary to selectively transmit power provided from the power source 101 to the second electronic device 200.

Taking this into account, the second connector 330 included in the second plug 310 may selectively transmit power provided from the power source 101 only to a second electronic device 200 which is configured to accept power. Particularly, according to the connection with the second receptacle 210 which is configured to accept power provided from the power source 101, the second connector 330 may include a switching circuit 331 that transmits the power provided from the power source 101. The switching circuit 331 may selectively transmit power to the second electronic device 200 connected with the second receptacle 210 in response to the control signal provided from the second receptacle 210 (or second electronic device 200).

The switching circuit 331 may include a power semiconductor device. The switching circuit 331 may selectively transmit power provided from the power source 101 in response to the control signal. Preferably, the control signal may be a low signal (“0”), and the power semiconductor device may transmit the power provided from the power source 101 to only a section into which the low signal (“0”) is input. For example, the power semiconductor device may be a p-type power semiconductor device.

Although the power provided by the first electronic device 100 is transmitted to the second electronic device 200 only when the second connector 330 of the second plug 310 according to an embodiment of the present invention is connected with the second connector 230 of the second receptacle 210, a signal having the same value as that of the control signal may be provided to the second plug 310 even though the second plug 310 is connected with a receptacle which is not configured to accept the power. In this case, a terminal that is connected with the receptacle which is not configured to accept the power may be damaged. Accordingly, in order to prevent the above problem from occurring, only the second plug 310 according to an embodiment of the present invention may be mechanically connected with the second receptacle 210. For example, the second plug 310 may include a predetermined protrusion 340, and the second receptacle 210 may include a protrusion accommodation unit 240 that can accommodate the protrusion 340.

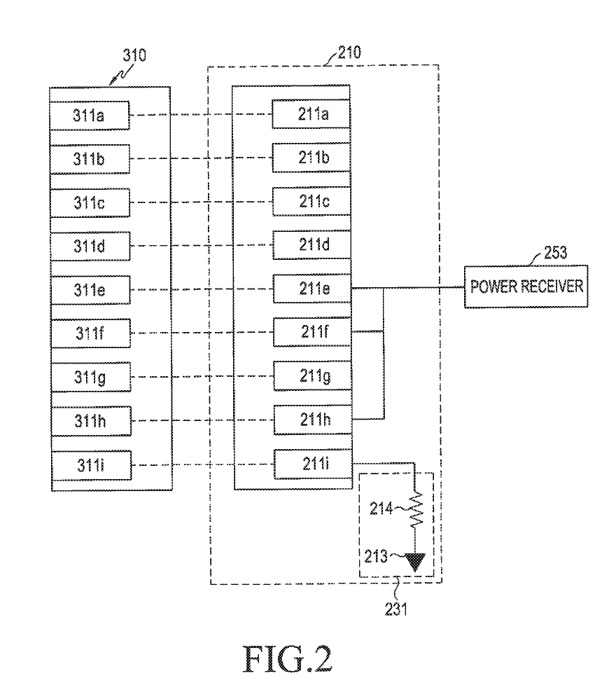

FIG. 2 illustrates a detailed configuration of the second receptacle according to an embodiment of the present invention.

Referring to FIG. 2, the second receptacle 210 may include the first connector 220 including first to fourth terminals 211a to 211d, and the second connector 230 including fifth to ninth terminals 211e to 211i. The first to ninth terminals 211a to 211i are connected to first to ninth terminals 311a to 311i included in the second plug 310, respectively.

As described above, the first terminal 211a included in the first connector 220 may be used as a terminal that supplies power to the second plug 310 based on the first USB interface (for example, USB 2.0 standard), the second and third terminals 211b and 211c may be used as terminals that perform data communication with the cable device 300 through the first USB interface (for example, USB 2.0 standard) scheme, and the fourth terminal 211d may be used as a ground terminal.

Further, the fifth terminal 211e, the sixth terminal 211f, and the eighth terminal 211h included in the second connector 230 may be used as terminals that transmit power provided from the second plug 310 to the power receiver 253 of the terminal apparatus.

Particularly, the ninth terminal 211 i included in the second connector 230 may be used as a terminal providing the control signal to the second plug 310. The ninth terminal 211 i may be connected with the ground end of the terminal apparatus or connected with a ground end 213 within the second receptacle 210 through a resistive device 214 within the second receptacle 210. The resistive device 214 having a predetermined value and the ground end 213 within the second receptacle 210 may be used as the control signal generator 231 providing the low signal (“0”). The seventh terminal 211g included in the first connector 220 may be connected the ground terminal.

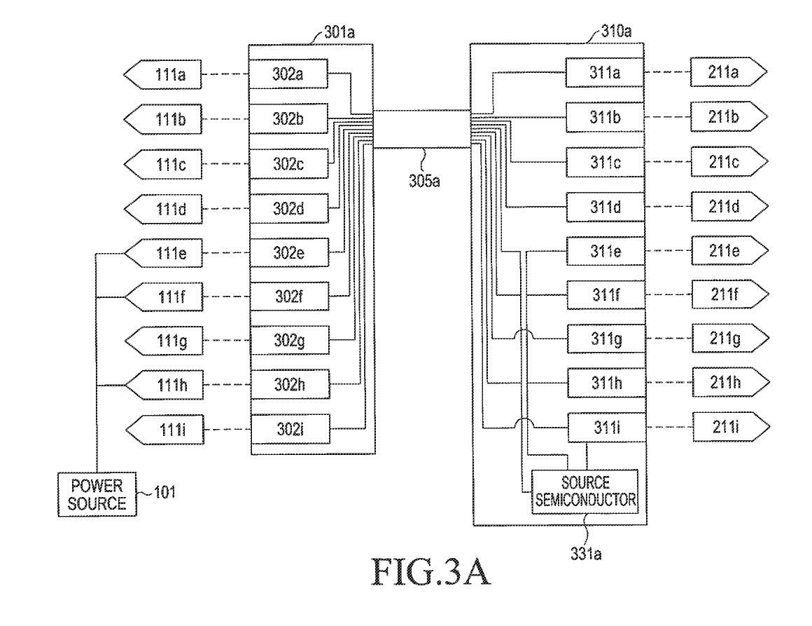

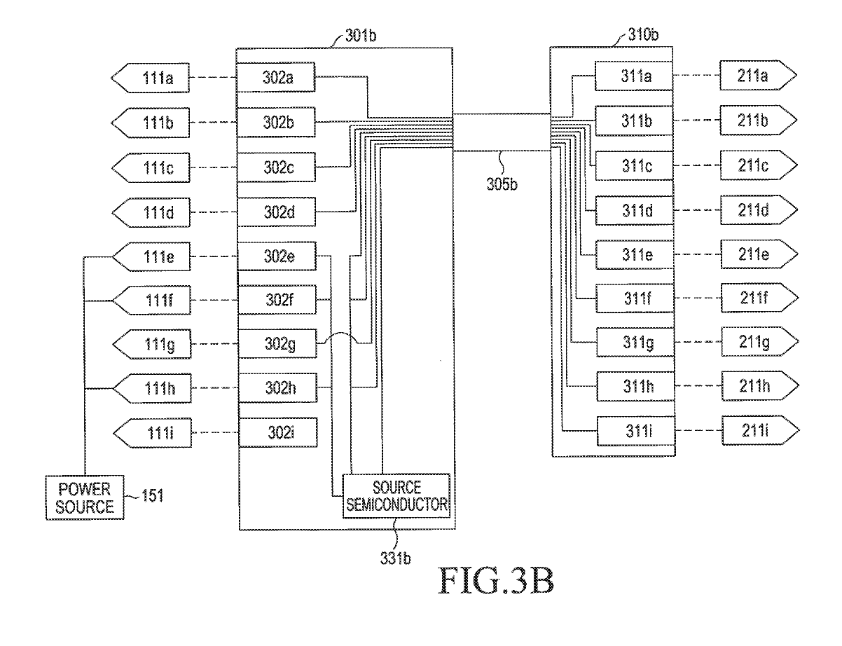

FIG. 3A illustrates an embodiment of a detailed configuration of the cable device according to an embodiment of the present invention.

Referring to FIG. 3A, a first plug 301a may include first to ninth connection terminals 302a to 302i connected with the connection terminals included in the first receptacle 110. The first to ninth connection terminals 302a to 302i connected with the first to ninth connection terminals 311a to 311i included in the second plug 310a, respectively, through a cable 305a.

The second plug 310a may include the first connector 320 including the first to fourth terminals 311a to 311d, and the second connector 330 including the fifth to ninth terminals 311e to 311i. The first to ninth terminals 311a to 311i may be connected with first to ninth terminals 211a to 211i included in the second receptacle 210, respectively. As described above, the first terminal 311a included in the first connector 320 may be used as the terminal that transmits power provided through the second receptacle 210 based on the first USB interface (for example, USB 2.0 standard), the second and third terminals 311b and 311c may be used as the terminals that perform data communication with the second receptacle 210 through the first USB interface (for example, USB 2.0 standard) scheme, and the fourth terminal 311d may be used as the ground terminal.

Further, the fifth terminal 311e, the sixth terminal 311f, and the eighth terminal 311h included in the second connector 330 may be used as terminals that transmit power provided from the power source 101 of the first electronic device 100 to the second receptacle 210. The ninth terminal 311i included in the second connector 330 may be used as a terminal that transmits the control signal provided from the second receptacle 210. The seventh terminal 311g included in the second connector 330 may be connected the ground terminal.

Further, the second connector 330 selectively transmit power provided from the outside only to the second receptacle 210 (or the second electronic device 200 connected with the second receptacle 210) which can accept the power. That is, when the second receptacle 210 which can accept the power provided from the power source 101 is connected with the second connector 330, the second connector 330 may include a switching circuit 331 that transmits the power provided from the power source 101. The switching circuit 331 selectively transmits power to the second receptacle 210 in response to the control signal provided from the second receptacle 210 (or the second electronic device 200 connected with the second receptacle 210).

The switching circuit 331 may include a power semiconductor device 331a. The power semiconductor device may include a source terminal (S), a drain terminal (D), and a gate terminal (G), wherein the source terminal (S) may be connected with the power source 101, and the drain terminal (D) may be connected with the fifth terminal 311e, the sixth terminal 311f, and the eighth terminal 311h that transmit power. Further, the gate terminal (G) may be connected with the ninth terminal 311i that receives the control signal provided from the second receptacle 210. For example, the source terminal (S) may be connected with terminals (for example, the fifth, sixth, and eighth terminals 111e, 111f, and 111h) connected with the power source 101 through the cable 305a.

According to such a configuration, the power semiconductor device 331a may selectively connect the source terminal (S) and the drain terminal (D) in response to the control signal input into the gate terminal (G). Preferably, the control signal a low signal (“0”), and the power semiconductor device 331a connect the source terminal (S) and the drain terminal (D) only in a section into which the low signal (“0”) is input. For example, the power semiconductor device 331a may be a p-type power semiconductor device.

In the embodiment of the present invention described above the switching circuit 331 is included in the second plug 310a. However, the present invention is not limited thereto. It is sufficient that the switching circuit 331 transmits power to the second receptacle 210 in response to the control signal provided from the second receptacle 210 (or the second electronic device 200 connected with the second receptacle 210). Accordingly, that the switching circuit 331 included in the first plug 301a can be an alternative to the switching circuit 331 included in the second plug 310a.

FIG. 3B illustrates another embodiment of the detailed configuration of the cable device according to an embodiment of the present invention.

According to another embodiment of the connector device illustrated in FIG. 3B, a first plug 301b may include first to ninth connection terminals 302a to 302i connected with the connection terminals 111a to 111i included in the first receptacle 110. The first plug 301b further may include a switching circuit (for example, power semiconductor device 331b) that selectively transmits power provided from the power source 101. The power semiconductor device 331b transmits power to a second plug 310b in response to a control signal provided from the second receptacle 210 (or the second electronic device 200 connected with the second receptacle 210) connected with the second plug 310b.

The power semiconductor device 331b may include a source terminal (S), a drain terminal (D), and a gate terminal (G), and the source terminal (S) may be connected with terminals (for example, the fifth, sixth, and eighth terminals 302e, 302f, and 302h) connected with the power source 101. The drain terminal (D) may be connected with the fifth terminal 311e, the sixth terminal 311f, and the eighth terminal 311h of the second plug 310b through the cable 305b. Further, the gate terminal (G) may be connected with the ninth terminal 311 i of the second plug 310b that receives the control signal.

The second plug 310b may include the first to ninth connection terminals 311a to 311i connected with the connection terminals 211a to 211i included in the second receptacle 210, respectively. The first to fourth connection terminals 311a to 311d and the seventh connection terminal 311g among the first to ninth connection terminals 311a to 311i are connected with the first to fourth connection terminals 302a to 302d and the seventh connection terminal 302g included in the first plug 301b, respectively, through the cable 305b. The fifth, sixth, and eighth terminals 311e, 311f, and 311h are connected with the drain terminal (D) included in the power semiconductor device 331b through the cable 305b, and the ninth terminal 311i is connected with the gate terminal (G) of the power semiconductor device 331b through the cable 305b.

According to such a configuration, the power semiconductor device 331b may selectively connect the source terminal (S) and the drain terminal (D) in response to the control signal input into the gate terminal (G), and transmit power provided from the power source 101 to the second receptacle 210 (or the electronic device connected with the second receptacle 210).

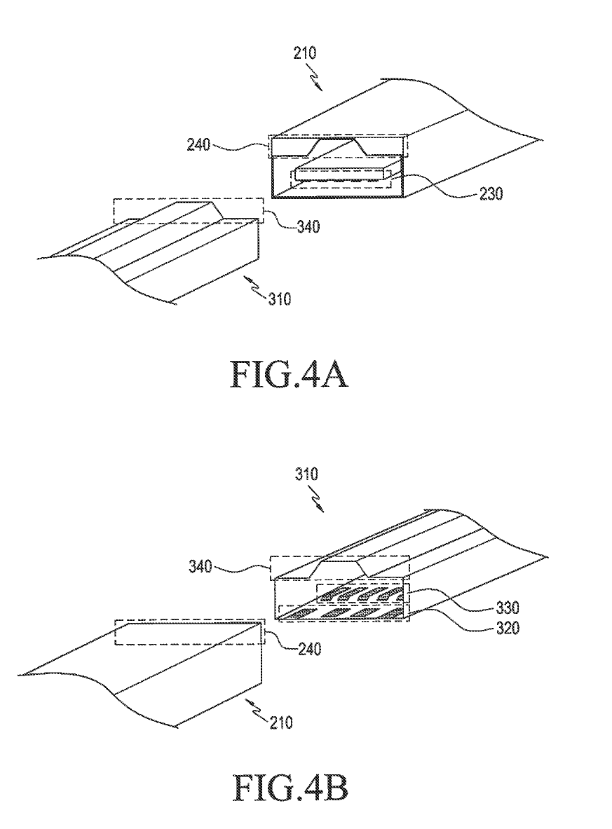

FIG. 4A is a perspective view illustrating a structure of the second receptacle according to an embodiment of the present invention, and FIG. 4B is a perspective view illustrating a structure of the second plug included in the connector device according to an embodiment of the present invention.

Referring to FIG. 4A first, the second receptacle according to the embodiment of the present invention basically may include the first connector 220 supporting the first USB interface (for example, USB 2.0 standard) and further may include the second connector 230. The first connector 220 and the second connector 230 may include the connection terminals as described above. When the second receptacle 210 is connected with the second plug 310, the first connector 220 and the second connector 230 may be located at positions corresponding to positions where the connection terminals included in the second plug 310 are located such that the first connector 220 and the second connector 230 are electrically connected with the connection terminals included in the second plug 310.

Particularly, the second receptacle 210 according to the embodiment of the present invention may include the protrusion accommodation unit 240 to restrict a connection with a connector or a plug other than the second plug 310 according to the embodiment of the present invention. When the second receptacle 210 and the second plug 310 are connected with each other, the protrusion accommodation unit 240 may include a groove corresponding to a size and a shape of the protrusion 340 in order to accommodate the protrusion 340 included in the second plug 310.

Referring to FIG. 4B, the second plug 310 according to the embodiment of the present invention may include the first connector 320 supporting the first USB interface (for example, USB 2.0 standard) and further may include the second connector 330.

The first connector 320 and the second connector 330 may include the connection terminals connected with the terminal apparatus as described above. When the second receptacle 210 is connected with the second plug 310, the first connector 220 and the second connector 230 may be located at positions corresponding to positions where the connection terminals included in the second receptacle 210 are located such that the first connector 220 and the second connector 230 are electrically connected with the connection terminals included in the second receptacle 210.

Particularly, the USB connector device according to an embodiment of the present invention may further include the protrusion 340 to restrict a connection with another receptacle other than the second receptacle 210 according to the embodiment of the present invention. When the second receptacle 210 and the second plug 310 are connected with each other, the protrusion 340 may be configured to have a size and a shape corresponding to those of the groove of the protrusion accommodation unit 240 in order to be accommodated into the protrusion accommodation unit 240 included in the second receptacle 210.

In a USB connection system according to an embodiment of the present invention, the first electronic device 100 may include the first receptacle 110 based on the first and second USB interface (for example, USB 2.0 and USB 3.0) standards, and the second electronic device 200 may include the second receptacle 210 configured according to the present invention. The cable device 300 may include the first plug 301 based on the first and second USB interface standards and the second plug 310 configured according to the present invention. The first receptacle 110 and the first plug 301 based on the first and the second USB interface (for example, USB 2.0 and USB 3.0) standards are connected with each other, and the second receptacle 210 and the second plug 310 configured according to the present invention are connected with each other. Accordingly, even though the first electronic device 100 may include the first receptacle 110 based on the first and second USB interface (for example, USB 2.0 and USB 3.0) standards, power may be supplied to the second electronic device 200 through the cable device 300 according to the embodiment of the present invention.

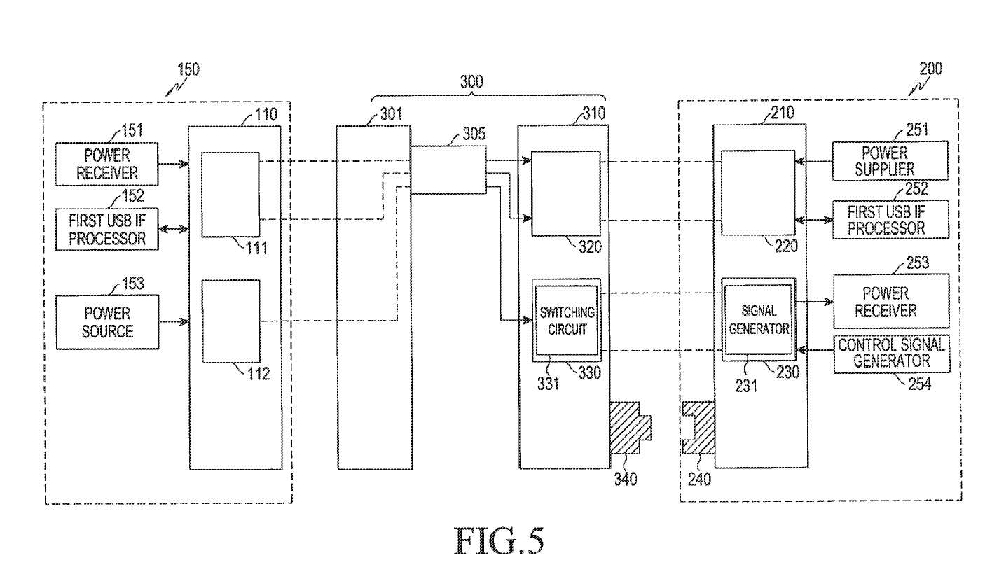

FIG. 5 is a block diagram illustrating a configuration of the USB connection system according to another embodiment of the present invention. The USB connection system according to another embodiment of the present invention is similar to the USB connection system according to the embodiment of the present invention described with reference to FIG. 1. However, a first electronic device 150 included in the USB connection system according to another embodiment of the present invention is somewhat different from the first electronic device 100 included in the USB connection system according to the embodiment of FIG. 1.

Hereinafter, a configuration of the USB connection system according to FIG. 5 will be described. Components of the USB connection system according to FIG. 5 which are the same as those of the USB connection system according to the embodiment of FIG. 1 are designated by the same reference numerals. Further, in the USB connection system according to the embodiment of FIG. 5, the components having the same reference numerals as those of the USB connection system according to the embodiment of FIG. 1 are configured in the same way as that of the USB connection system according to the embodiment of FIG. 1, so that detailed descriptions of the same components are will be described with reference to the embodiment of FIG. 1.

According to the USB connection system illustrated in FIG. 5, the first electronic device 150 and the second electronic device 200 include receptacles (first receptacle 110 and second receptacle 210, respectively), and are connected to each other through the cable device 300.

The cable device 300 may include the first plug 301 and the second plug 310 arranged at both ends of a cable 305. The first plug 301 is coupled and connected with the first receptacle 110, and the second plug 310 is coupled and connected with the second receptacle 210.

The first electronic device 150 may include the first receptacle 110 which can accommodate the first plug 301 for connection with the first plug 301. The first receptacle 110 may further include the first connector 111 and the second connector 112.

The first electronic device 150 process power reception and data transmission/reception based on the USB interface, and refers to a device, for example, an electronic device such as a mobile communication terminal, a portable terminal, or a tablet Personal Computer (PC), that may supply power stored inside or power input from the outside to another electronic device. Accordingly, the first electronic device 150 may include a power receiver 151 that receives power provided from the outside based on the first USB interface and a first USB interface processor 152 that transmits/receives a data signal based on the first USB interface. Further, the first electronic device 150 may include a power source 153 that converts power input from the outside (or power stored inside) to power which can be supplied to the electronic device and provides the converted power.

The power source 153 is connected with the second connector 112 of the first receptacle 110 and may provide output power to another electronic device through the second connector 112 of the first receptacle 110. The power source 153 may be one or more batteries (not shown) arranged at a housing of the first electronic device 150 or a power circuit that supplies power to the battery. The power source 153 may supply power input from an external power source (not shown) through a wired cable connected to a connector included in the first electronic device 150 to components (or another external electronic device) included in the first electronic device 150. Also, the power source 153 may supply power wirelessly input from an external power source through a wireless charging technology to components (or another external electronic device) included in the first electronic device 150.

In the USB connection system according to the embodiment of the present invention of FIG. 5, the first electronic device 150 process data transmission/reception with the second electronic device 200 through the cable device 300 based on the first USB interface (for example, USB 2.0 interface). Further, the first electronic device 150 receive power from the second electronic device 200 based on the first USB interface (for example, USB 2.0 interface). In addition, the first electronic device 150 may supply power to the second electronic device 200 through an expansion terminal defined by the second USB interface (for example, USB 3.0 interface). Therefore, according to the embodiment of the present invention as described above, the power provided by the second electronic device (for example, a laptop computer) including the second receptacle can be supplied to the first terminal apparatus (for example, a portable terminal apparatus) through the cable device based on the first USB interface, and the first terminal apparatus (for example, the portable terminal apparatus) can supply power to the second electronic device (for example, the laptop computer) as necessary.

While the present invention has been shown and described with reference to certain embodiments thereof, it will be understood by those skilled in the art that various changes in form and detail may be made therein without departing from the spirit and scope of the invention as defined by the appended claims.

What is claimed is:

1. An electronic device comprising:
a power receiver that manages power transmitted from outside the electronic device; and
a receptacle including a plurality of first basic connection terminals based on a first Universal Serial Bus (USB) interface and a plurality of first expansion connection terminals based on a second USB interface, wherein the first expansion connection terminals include one or more first power supply terminals that transmit power received through a cable device connected with the receptacle to the power receiver.

2. The electronic device of claim 1, wherein the receptacle includes one or more control signal terminals that transmit a control signal for determining whether to supply power.

3. The electronic device of claim 2, further comprising a control signal generator that generates the control signal for determining whether to supply the power and is connected with the one or more control signal terminals.

4. The electronic device of claim 3, wherein the receptacle includes the control signal generator.

5. The electronic device of claim 2, wherein the cable device includes a first plug mounted to the receptacle to be connected with the plurality of first basic connection terminals and the plurality of first expansion connection terminals.

6. The electronic device of claim 5, wherein the first plug includes a plurality of second basic connection terminals and a plurality of second expansion connection terminals connected with the plurality of first basic connection terminals and the plurality of first expansion connection terminals, respectively.

7. The electronic device of claim 5, wherein the first plug includes one or more second power supply terminals connected to the one or more first power supply terminals, and a switching circuit that selectively outputs power to the one or more second power supply terminals based on the control signal.

8. The electronic device of claim 7, wherein the switching circuit includes a power semiconductor device including a source terminal connected with a terminal that receives power, a drain terminal connected with a terminal that outputs power, and a gate terminal connected with a terminal that receives the control signal.

9. The electronic device of claim 5, wherein the cable device includes a second plug connected to a receptacle of a power supply electronic device that supplies the power, and the receptacle of the power supply electronic device and the second plug include a plurality of connection terminals based on the second USB interface.

10. The electronic device of claim 5, wherein the first plug connected with the receptacle includes a protrusion, and the receptacle includes a protrusion accommodation unit that accommodates the protrusion.

11. A cable device comprising:
a first plug including a plurality of first basic connection terminals based on a first USB interface and a plurality of first expansion connection terminals based on a second USB interface; and
a second plug including a plurality of connection terminals based on the second USB interface,
wherein the first expansion connection terminals include one or more power supply terminals connected with a receptacle included in an electronic device that receives power, to transmit power supplied through the second plug to the receptacle.

12. The cable device of claim 11, wherein the first expansion connection terminals include one or more control signal terminals that transmit a control signal for determining whether to supply power provided from the receptacle.

13. The cable device of claim 12, wherein the first plug includes a switching circuit that selectively outputs power to the one or more power supply terminals based on the control signal.

14. The cable device of claim 13, wherein the switching circuit includes a power semiconductor device including a source terminal connected with a terminal that receives power, a drain terminal connected with a terminal that outputs power, and a gate terminal connected with the control signal terminal.

15. The cable device of claim 1, wherein the first plug includes a protrusion connected with a protrusion accommodation unit included in the receptacle.

16. A receptacle device comprising:
a plurality of first basic connection terminals based on a first USB interface; and
a plurality of first expansion connection terminals based on a second USB interface,
wherein the first expansion connection terminals include one or more first power supply terminals that transmit power received through a cable device connected with a receptacle to a power receiver included in an electronic device.

17. The receptacle device of claim 16, wherein the receptacle includes one or more control signal terminals that transmit a control signal for determining whether to supply power.

18. The receptacle device of claim 17, wherein the receptacle includes a control signal generator that generates the control signal and provides the generated control signal to the one or more control signal terminals.

19. The receptacle device of claim 17, wherein the one or more control signal terminals transmit the control signal to a switching circuit included in a plug connected with the receptacle.

20. The receptacle device of claim 16, further comprising a protrusion accommodation unit that accommodates a protrusion formed on a plug connected with the receptacle.
